(19) United States
(12) Patent Application Publication
(10) Pub. No.: US 2016/0149685 A1
(43) Pub. Date: May 26, 2016

(54) METHOD AND APPARATUS FOR WIRELESS COMMUNICATION

(71) Applicant: Samsung Electronics Co., Ltd., Gyeonggi-do (KR)

(72) Inventor: Mark G. Rison, Cambridge (GB)

(73) Assignee: Samsung Electronics Co., Ltd.

(21) Appl. No.: 14/550,472

(22) Filed: Nov. 21, 2014

(51) Int. Cl. H04L 5/00; H04W 72/04

(52) U.S. Cl. CPC H04L 5/0055; H04W 72/0446

(57) ABSTRACT

A method for communicating over a wireless network is provided. The method includes receiving, at a Station (STA), a frame over the wireless network; if the frame is corrupted, determining if the frame requires acknowledgement; and if the frame requires acknowledgement, transmitting a Negative Ack frame (NAck).

### BACKGROUND OF THE INVENTION

1. Field of the Invention

The present invention relates generally to a method and apparatus for wireless communication, and more particularly, to a method and apparatus which allows next-generation devices to use the medium more effectively when a received frame is corrupted.

2. Description of the Related Art

The development of next-generation High Efficiency Wireless (HEW) communication networks, e.g., next-generation networks, and devices including both Access Points (APs) and Stations (STAs), configured for use in such communication networks is on the rise. A primary focus when developing such communication networks is to increase an efficiency in which the next-generation networks can operate.

Unfortunately, known receiving devices, e.g., receiving Stations (STAs), that are operable over either the next-generation networks and the legacy networks, are not capable of efficiently handling situations when a received frame is corrupted. That is, in such situations these receiving devices do not acknowledge the received, corrupted frame, which, in turn, may result in a decrease in efficiency of the respective communication network, which, in turn, may result in degradation in a quality of experience provided to user of the next-generation devices and/or legacy devices.

Therefore, there exists a need for a method and apparatus for improving communication efficiency amongst a plurality of STAs in a wireless network.

### SUMMARY OF THE INVENTION

The present invention has been made to address the above problems and/or disadvantages, and to provide at least the advantages described below.

Accordingly, an aspect of the present invention is to provide a method and apparatus for improving communication efficiency amongst a plurality of STAs in a wireless network.

Specifically, an aspect of the present invention provides a Negative Acknowledgement (NAck) frame that may be used in a situation where a received frame is corrupted but can still be recognized, i.e., the frame is only slightly corrupted. Such a NAck frame can help a STA, an AP and third parties (another STA and/or AP), communicate with each other within a wireless network, regardless of the type of wireless network, e.g., a next-generation network or a legacy network.

Therefore, in accordance with an aspect of the present invention, a method for communicating over a wireless network is provided. The method includes receiving, at a STA, a frame over the wireless network; if the frame is corrupted, determining if the frame requires acknowledgement; and if the frame requires acknowledgement, transmitting a NAck.

In accordance with another aspect of the present invention, a method for communicating a frame between a plurality of STAs within a wireless network is provided. The method includes transmitting a frame from a first STA of the plurality of STAs; receiving the frame at a second STA of the plurality of STAs; if the frame is corrupted, determining at the second STA if the frame requires acknowledgement; and if the frame requires acknowledgement, transmitting from the second STA a NAck to the first STA.

In accordance with yet another aspect of the present invention, a STA is provided. The STA includes at least one processor configured to receive a frame over a wireless network, if the frame is corrupted, to determine if the frame requires acknowledgement, and if the frame requires acknowledgement, to transmit a NAck.

In accordance with another aspect of the present invention, a sniffer for communicating over a wireless network is provided. The sniffer includes at least one processor configured to detect a NAck frame, which was transmitted from a STA in response to the STA receiving a corrupted frame over the wireless network, and to determine if the received frame required acknowledgement.

In accordance with still another aspect of the present invention, a non-transitory computer-readable medium having stored thereon a plurality of executable instructions is provided, the plurality of instructions comprising instructions to: transmit/receive, at a STA, a frame over a wireless network; if the frame is corrupted, determine if the frame requires acknowledgement; and if the frame requires acknowledgement, transmit a NAck frame.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a wireless network, according to an embodiment of the present invention;

FIG. 2 is a block diagram illustrating components of the STAs shown in FIG. 1, according to an embodiment of the present invention;

FIG. 3 is a signaling diagram divided by a dashed line illustrating, in an upper half, a signaling sequence between three STAs that communicate over a prior art wireless network, and, in a lower half, a signaling sequence between three STAs that communicate over a wireless network according to an embodiment of the present invention;

FIG. 4 is a flowchart illustrating a method for communicating over a wireless network, according to an embodiment of the present invention; and

FIG. 5 is a flowchart illustrating a method for communicating a frame between a plurality of STAs within a wireless network, according to an embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configuration and components are merely provided to assist in the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

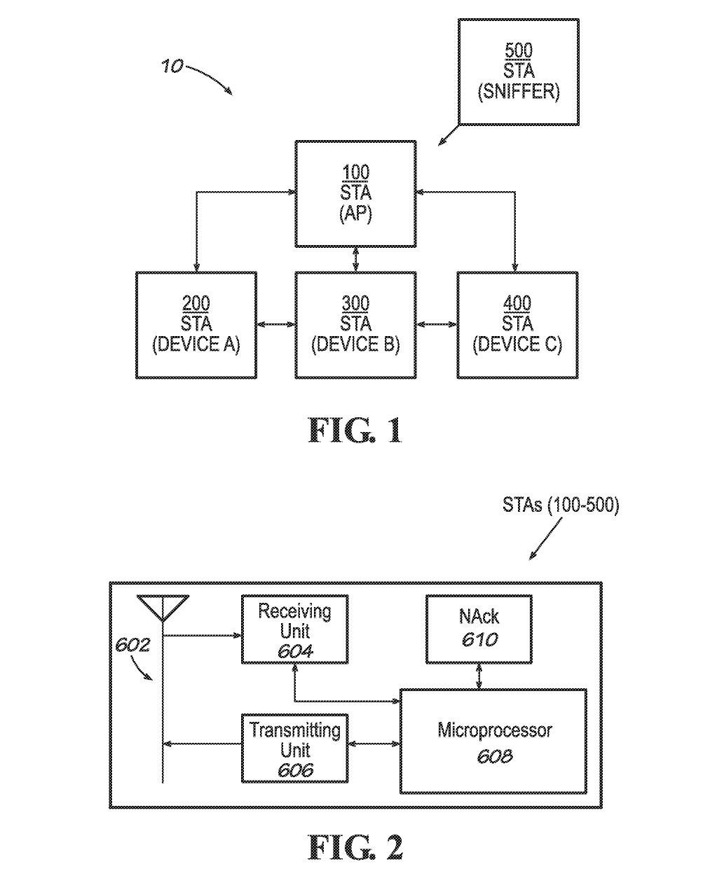

FIG. 1 illustrates a wireless communication network 10, according to an embodiment of the present invention. The network 10 includes a plurality of STAs that are capable of communicating over the network 10. For illustrative purposes, the plurality of STAs is shown including a STA 100, e.g., an AP or base STA, and a plurality of associated user STAs 200, 300, 400, e.g., DEVICES A-C. The individual user STAs 200, 300, 400 may be embodied in the form of a cell phone, a Personal Digital Assistant (PDA), a laptop, a workstation, a personal computer, a video camcorder, etc. As can be appreciated, one or more of the user STAs 200, 300, and 400 can be embodied as another AP. Moreover, it is contemplated that the AP can also be component of a larger system or device, rather than being a dedicated AP.

One or more STAs 500 may be embodied in a form of a sniffer (FIG. 1) and may be implemented in the network 10, as will be described in more detail below.

While the AP 100 will be described herein as the transmitting device and the user STAs 200, 300, 400 as the receiving devices, it will be understood by those skilled in the art that both the AP 100 and STAs 200, 300, 400 can each receive and transmit signals over the network 10.

Moreover, it should be appreciated that the user STAs 200, 300, 400 may be connected to other devices and/or networks with which these STAs may communicate. Further, though FIG. 1 only shows five stations within the network 10, it should be appreciated that the network 10 may include more or less than five stations.

The network 10 can operate under one or more of the IEEE 802.11 standards such as the IEEE 802.11n, IEEE 802.11ax, IEEE 802.11ac, and IEEE 802.11a/b/g standards. However, other IEEE 802.11 standards are contemplated.

For illustrative purposes, the user STAs 200, 300 are described herein as next-generation devices, i.e., the STAs 200, 300 are configured for communicating over the IEEE 802.11ax wireless standard, and the user STA 400 is described herein as a legacy device, i.e., STA 400 is configured for communicating over the IEEE 802.11a/b/g/n/ac wireless standard.

The STA 100 is described herein as a next-generation device and is capable of communicating with other next-generation devices and legacy devices within the network 10. In other words, the STA 100 is capable of communicating with the user STAs 200, 300, 400 according to the IEEE 802.11ax wireless standard and the IEEE 802.11a/b/g/n/ac wireless standard.

FIG. 2 is a diagram illustrating an example of an embodiment of the components that may be provided in each of the STAs 100-500 in the network 10. As shown in FIG. 2, each of the STAs 100-500 is provided with at least one antenna 602, at least one receiving unit 604, at least one transmitting unit 606, and at least one microprocessor (μp) 608. These components illustrated in FIG. 2 allow the STAs 100-500 to selectively transmit and receive frames within the network 10.

STAs, 100, 200, and 300, also include a NAck unit 610. The NAck unit 610 generates, recognizes and transmits a NAck frame upon reception of a corrupted frame that requires acknowledgement including a frame inside an A-MPDU (or not inside an A-MPDU), Request-to-Send (RTS) frame, BlockAck Request (BAR) frame.

Although the transmitting unit 606, the receiving unit 604, the ftp 608, and the NAck unit 610 are depicted as separate entities in FIG. 2 persons of ordinary skill in the in should appreciate that the present invention is not so limited. For example, the μp 608 can be programmed to generate, recognize and transmit a. NAck frame upon reception of a corrupted frame that requires acknowledgement.

The receiving unit 604 receives modulated frames over the network 10 and provides the modulated messages to the μp 608 for demodulating.

The transmitting unit 606 of the STAs 100-400 transmits one or more modulated frames provided by the μp 608 over the network 10, according to one or more transmitting protocols. For example, the STAs 100-400 transmit frames including, but not limited to, control frames, data frames, management frames, and extension frames.

Moreover, the transmitting unit 606 transmits frames in accordance with special priority requirements, e.g., after a pre-defined idle period following a preceding frame transmission. This pre-defined idle period is equal to a Distributed Coordination Function (DCF) Inter Frame Space (DIFS) or an Enhanced Distributed Channel Access Function (EDCAF) Arbitration IFS (AIFS). The different IFSs are defined in the IEEE 802.11 standard as time gaps on the radio medium and are fixed. One such gap is the above mentioned DIFS and two others are the Extended IFS (EIFS) and the Short IFS (SIFS).

The SIFSs are used for the highest-priority transmissions. Once these high-priority transmissions begin, the network 10 becomes busy, so frames transmitted after the SIFS interval has elapsed have priority over lower-priority frames that can be transmitted only after longer intervals, such as a Point Coordination Function IFS (PIFS) and the DIFS intervals described above.

The EIFS are used to allow ongoing transmissions to continue and end successfully even though another station (that back-offs for the duration of EIFS) has not received the transmission, e.g. it could not demodulate the message. In the IEEE 802.11 standard, the EIFS are used by the DCF or an Enhanced Distributed Channel Access Function (EDCAF) whenever the PHY has indicated to the Medium Access Control (MAC) that a frame transmission did not result in the correct reception of a complete MAC frame with correct Frame Check Sequence (FCS) values. The EIFS interval begins following indication by the PHY that the medium is idle after detection of an erroneous frame, e.g., a corrupted frame has been received.

In accordance with the embodiments of the present invention, if the STA 100 transmits a frame that requires an acknowledgement frame, to the next-generation STA 200 and the legacy STA 400, the STA 100 waits according to ACKTimeout after the end of the transmission before concluding the transmission has failed.

Table 1 shows the value of the ACKTimeout for various acknowledgement formats, excluding an aSIFSTime, which is the time at which the acknowledgement would be expected, and the aAirPropagationTime component of aSlotTime, which is a function of the width of the Basic Service Set (BSS) and is the same for the acknowledgement and Nack cases.

TABLE 1

| | | aSlotTime + |
|---|---|---|
| | aSlotTime − | aRxPHYStartDelay − |
| | aAirPropagationTime | aAirPropagationTime |
| Ack format | (μs) | (μs) |
| 11b, long slots, | 20 | 212 |
| long preamble | | |
| 11b, long slots, | 20 | 116 |
| short preamble | | |
| 11g, long slots | 20 | 44 |
| 11g, short slots | 9 | 33 |
| 11n/11ac, long slots | 20 | 53 |
| 11n/11ac, short | 9 | 42 |
| slots/5 GHz band | | |

As can be seen from Table 1, there is a considerable delay between the ACKTimeout when compared with the slot time. For example, with an acknowledgement format of the IEEE 802.11b standard, long slots, long preamble, the aSlotTime is 20 μs, while the ACKTimeout is 212 μs. Thus, in accordance with the present invention, introducing a NAck frame, after receiving a corrupted frame, allows for some of this delay to be reclaimed at the STA 100, e.g., the data originator. Moreover, introducing the NAck frame allows the STA 100 to continue using the rest of the Transmission Opportunity (TXOP) when the TXOP Limit is non-zero and some medium time remains, even if the STA 100 does not support PIFS recovery, as will be described in greater detail below. Furthermore, using the NAck allows other receiving STAs to revert to using DIFS/AIFS, saving these STAs delay too, especially where the TXOP Limit is zero. For example, if the STAs 200, 400 each receive the corrupted frame, the STA 400, assuming that it is not capable of transmitting a NAck frame, would resort to using EIFS, while the STA 200, assuming that it is capable of transmitting the NAck frame, would transmit the NAck frame to the surrounding STAs, e.g., STA 100 and the STA 400. Regarding the STA 400, reception of the NAck frame would indicate to the STA 400 to switch to using DIFS/AIFS, thereby allowing the STA 400 to transmit frames without extra delay.

In accordance with embodiments of the present invention, a STA, e.g., STA 200, could verify that the received, corrupted frame was, with high probability, one which was addressed to it and which expected acknowledgement based on one or more of the following indicators: all of a protocol version, type, and subtype of the frame; whether To/From Distribution Service (DS) bits match both of a BSS type and a role of the second STA 200; whether an address one of the frame is the second STA's address; whether an address two of the frame is a known peer STA's address; whether a Physical (PHY) header of the frame signals an Aggregate-Medium Access Control Protocol Data Unit (A-MPDU) and whether all MPDUs in an High Throughput A-MPDU (HT A-MPDU) are corrupt; and whether an MPDU signals a Very HT (VHT) single MPDU and whether all MPDUs in a non-single VHT A-MPDU are corrupt. As can be appreciated, other methods can also be used by the STA to verify that the received, corrupted frame was, with high probability, one which was addressed to it and which expected acknowledgement.

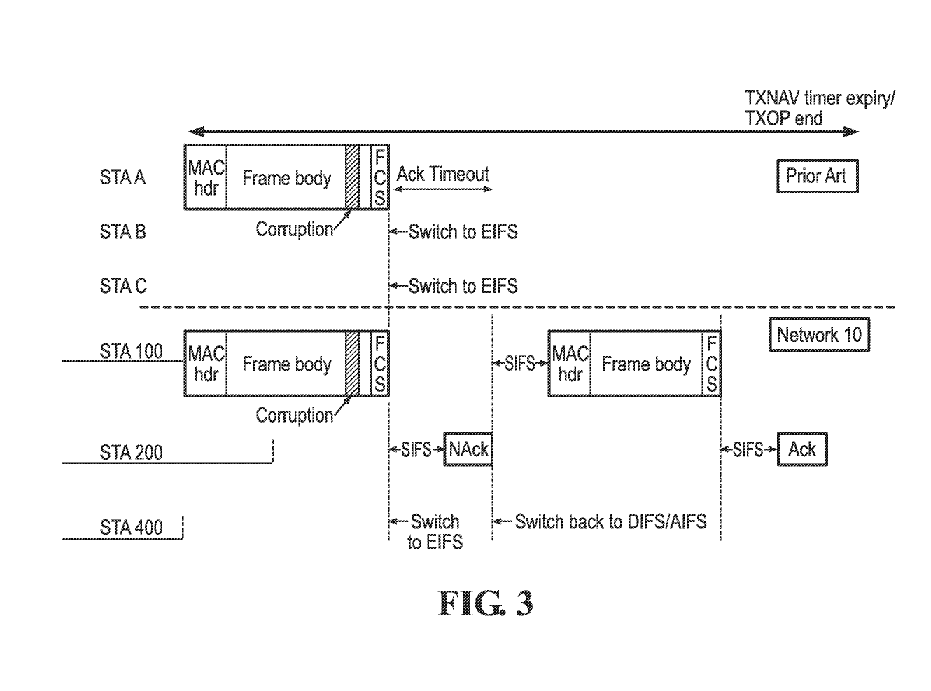

FIG. 3 is a signaling diagram divided by a dashed line illustrating, in an upper half, a signaling sequence between three STAs, e.g., STAs A, B, C (which are analogous to STAs 100, 200, 400), that communicate over a prior art wireless network, and, in a lower half, a signaling sequence between three STAs, e.g., STAs 100, 200, 400, that communicate over a wireless network according to an embodiment of the present invention.

Referring to the top half of FIG. 3, STA A is a TXOP holder (where the TXOP Limit is non-zero) and transmits a frame to STA B, with STA C within range. As illustrated in the top half of FIG. 3, the body of this frame is corrupted, so STA B and STA C perceive an FCS error. In accordance with IEEE 802.11-2012 wireless standards, both STA B and STA C would ignore the received, corrupted frame and switch to using EIFS, thereby slowing their subsequent access to the wireless medium. Furthermore, STA A would have to wait for ACKTimeout before determining transmission failure, and if STA A did not support PIFS recovery the medium would potentially be left wastefully idle until the expiry of a Transmission Network Allocation Vector (TXNAV) timer, corresponding to the end of the TXOP STA A held.

Referring to the bottom half of FIG. 3, the STA 100 transmits a frame, which is corrupted, over the network 10 to STAs 200, 400. For illustrative purposes, it is assumed that the STA 200 is a new-generation device and is configured to generate and transmit a NAck frame upon reception of a corrupted frame. Moreover, as STA 400 is a legacy device, it is not configured to generate or transmit a NAck frame upon reception of a corrupted frame.

Upon reception of the received, corrupted frame at the STA 400, the STA 400 switches to using EIFS, as would conventional STA C (see top half of FIG. 3, for example).

Conversely, upon reception the received corrupted frame at STA 200, unlike the conventional STA 400, after the STA 200 has determined that the received, corrupted frame requires acknowledgement, after SIFS, the STA 200 generates and transmits a NAck frame to the STA 100.

The STA 100 would, on receiving the NAck, proceed per the usual medium access rules (including subsequent transmission after SIFS, if the TXOP limit had not been reached), thereby making use of the remaining portion of the TXOP it holds.

As noted above, when the STA 400 receives the NAck, the STA 400 may switch from using EIFS, as a result of receiving corrupted frame, to using DIFS/AIFS, thereby maintaining good subsequent access to the wireless medium.

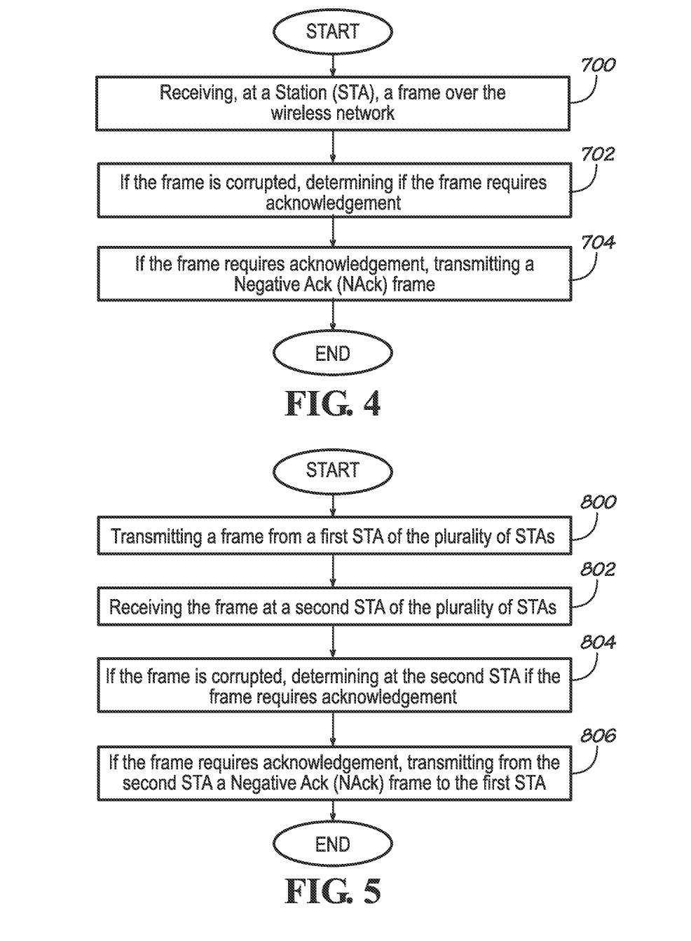

FIG. 4 is a flowchart illustrating a method for communicating over a wireless network, according to an embodiment of the present invention.

At step 700, a frame is received at the STAs 200, 400 over the wireless network from the STA 100. As discussed above, if the frame is corrupted (including a frame inside an A-MPDU (or not inside an A-MPDU), Request-to-Send (RTS) frame, BlockAck Request (BAR) frame) it can be determined by the NAck unit 610 of the STA 200 if the frame requires acknowledgement, at step 702; this can be accomplished utilizing one or more of the aforementioned indicators, e.g., all of a protocol version, type, and subtype of the frame. If it is determined that the frame requires acknowledgement, the NAck unit 610 generates a NAck frame that is transmitted to the STA 100 and/or STA 400, at step 704.

FIG. 5 is a flowchart illustrating a method for communicating a frame between a plurality of STAs within a wireless network, according to an embodiment of the present invention.

At step 800, a frame is transmitted from the STA 100. The frame is received at STAs 200, 400, at step 802. If the frame is corrupted, it is determined by the NAck unit 610 of the STA 200 if the frame requires acknowledgement, at step 804; this can be accomplished utilizing one or more of the aforementioned indicators, e.g., whether To/From Distribution Service (DS) bits match one of a Basic Service Set (BSS) type and a role of the STA 200. If the frame requires acknowledgement, the NAck unit 610 generates a NAck frame that is transmitted from the STA 200 to the STA 100 and/or the STA 400, at step 806.

As noted above, the network 10 may also include a STA 500 that is embodied in the form of a sniffer (FIG. 1). The STA 500, or packet analyzer, can be used in the network 10 to intercept and log traffic passing over the network 10. The STA 500 may be implemented in hardware or software. As data streams flow across the network 10, the STA 500 can be configured to capture data and, if needed, demodulate and analyze their content or provide the captured data to an analyzing tool for further processing. The captured data may for instance be analyzed to obtain information about the network 10 or the communication, e.g. to debug the communication or to diagnose problems of the network 10.

Accordingly, in accordance with another embodiment of the present invention, the STA 500 is embodied in the form of a sniffer for communicating over a wireless medium and includes the μp 608 and/or the NAck unit 610 which are configured to detect a NAck frame, which was transmitted from a STA, e.g., STA 200, in response to the STA 200 receiving a frame over the network 10, and to determine if the received frame required acknowledgement.

The present invention or aspects thereof are capable of being distributed in the form of a non-transitory computer-readable program product stored in a tangible computer medium having stored thereon a plurality of executable instructions. The plurality of executable instructions are provided in a variety of forms for execution on a processor, processors, or the like, and the present invention applies equally regardless of the particular type of signal-bearing media used to actually carry out the distribution.

The plurality of instructions comprise instructions to: transmit/receive, at a STA, e.g., STAs 100-400, a frame over the wireless network; if the frame is corrupted, determine if the frame requires acknowledgement; and if the frame requires acknowledgement, transmit a NAck frame.

The non-transitory computer readable program product can be in the form of microcode, programs, routines, and symbolic languages that provide a specific set or sets of ordered operations that control the functioning of the hardware and direct its operation, as known and understood by those skilled in the art. Examples of computer readable media include, but are not limited to: nonvolatile hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs. DVD-R/RWs, DVD+R/RWs, flash drives, memory sticks, HD-DVDs, mini disks, laser disks, Blu-ray disks, and other newer types of memories, and transmission type media such as digital and analog communication links.

In accordance with the embodiments of the present invention, the non-transitory computer readable program product can be installed on the STA 400 so that the STA 400 can perform the aforementioned NAck operations that were described herein with respect to the STAs 100-300 and 500.

While the above embodiments have described herein as using a NAck frame for indicating to the STA 100 that the received frame was corrupted, other frames may also be used. For example, the acknowledgement frame, Clear-to-Send (CTS) frame, or BlockAck Request frame can be modified or enhanced to indicate to the STA 100 that the received frame was corrupted. An advantage of modifying one of these existing frames as opposed to using the NAck frame would be that the STA 400 would not invoke EIFS, as it might if it received the NAck frame.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for communicating over a wireless network, the method comprising:
receiving, at a Station (STA), a frame over the wireless network;
if the frame is corrupted, determining if the frame requires acknowledgement; and
if the frame requires acknowledgement, transmitting a Negative Ack (NAck) frame.

2. The method according to claim 1, wherein the corrupted frame is one of a frame not inside an A-MPDU, a frame inside an A-MPDU, a Request-to-Send (RTS) frame and Block Ack Request (BAR) frame.

3. The method according to claim 1, wherein transmitting the NAck frame is performed after a Short InterFrame Space (SIFS) interval.

4. The method according to claim 1, wherein determining if the frame requires acknowledgement comprises determining at least one of:
all of a protocol version, type, and subtype of the frame;
whether To/From Distribution Service (DS) bits match both of a Basic Service Set (BSS) type and a role of the STA;
whether an address one of the frame is the STA's address;
whether an address two of the frame is a known peer STA's address;
whether a Physical (PHY) header of the frame signals an Aggregate-Medium Access Control Protocol Data Unit (A-MPDU) and whether all MPDUs in an High Throughput A-MPDU (HT A-MPDU) are corrupt; and
whether an MPDU signals a Very HT (VHT) single MPDU and whether all MPDUs in a non-single VHT A-MPDU are corrupt.

5. The method according to claim 3, wherein transmitting the NAck frame comprises transmitting the NAck frame to one of an Access Point (AP) that originated the frame, a peer STA that originated the frame.

6. The method according to claim 5, wherein, upon receiving the NAck at the AP, and after the SIFS interval, transmitting the frame from the AP if a Transmission Opportunity (TXOP) time of the AP has not expired.

7. A method for communicating a frame between a plurality of Stations (STAs) within a wireless network, the method comprising:
transmitting a frame from a first STA of the plurality of STAs;
receiving the frame at a second STA of the plurality of STAs;
if the frame is corrupted, determining at the second STA if the frame requires acknowledgement; and
if the frame requires acknowledgement, transmitting from the second STA a Negative Ack (NAck) frame to the first STA.

8. The method according to claim 7, wherein the corrupted frame is one of a frame not inside an A-MPDU, a frame inside an A-MPDU, a Request-to-Send (RTS) frame and Block Ack Request (BAR) frame.

9. The method according to claim 7, wherein transmitting the NAck frame is performed after a Short InterFrame Space (SIFS) interval.

10. The method according to claim 7, wherein determining if the frame requires acknowledgement comprises determining at least one of:
all of a protocol version, type, and subtype of the frame;
whether To/From Distribution Service (DS) bits match both of a Basic Service Set (BSS) type and a role of the second STA;
whether an address one of the frame is the second STA's address;
whether an address two of the frame is a known peer STA's address;
whether a Physical (PHY) header of the frame signals an Aggregate-Medium Access Control Protocol Data Unit (A-MPDU) and whether all MPDUs in an High Throughput A-MPDU (HT A-MPDU) are corrupt; and
whether an MPDU signals a Very HT (VHT) single MPDU and whether all MPDUs in a non-single VHT A-MPDU are corrupt.

11. The method according to claim 9, wherein transmitting the NAck frame comprises transmitting the NAck to one of a peer STA of the second STA and an Access Point (AP) within the wireless network.

12. The method according to claim 10, wherein, upon receiving the NAck at the first STA, and after the SIFS interval, transmitting the frame from the first STA to the second STA if a Transmission Opportunity (TXOP) time of the first STA has not expired.

13. The method according to claim 12, wherein, upon receiving the NAck at the peer STA, and after an Extended IFS (EIFS) interval has commenced, switching to one of a Distributed Coordination Function IFS (DIFS) and Arbitration IFS (AIFS).

14. A Station (STA) comprising:
at least one processor configured to receive a frame over a wireless network, wherein if the frame is corrupted, to determine if the frame requires acknowledgement, and if the frame requires acknowledgement, to transmit a Negative Ack (NAck) frame.

15. The STA according to claim 14, wherein the corrupted frame is one of a frame not inside an A-MPDU, a frame inside an A-MPDU, a Request-to-Send (RTS) frame and Block Ack Request (BAR) frame.

16. The STA according to claim 14, wherein the at least one processor is further configured to transmit the NAck frame after a Short InterFrame Space (SIFS) interval.

17. The STA according to claim 14, wherein the at least one processor is further configured to determine if the frame requires acknowledgement by determining at least one of:
all of a protocol version, type, and subtype of the frame;
whether To/From Distribution Service (DS) bits match both of a Basic Service Set (BSS) type and a role of the STA;
whether an address one of the frame is the STA's address;
whether an address two of the frame is a known peer STA's address;
whether a Physical (PHY) header of the frame signals an Aggregate-Medium Access Control Protocol Data Unit (A-MPDU) and whether all MPDUs in an High Throughput A-MPDU (HT A-MPDU) are corrupt; and
whether an MPDU signals a Very HT (VHT) single MPDU and whether all MPDUs in a non-single VHT A-MPDU are corrupt.

18. The STA according to claim 14, wherein the at least one processor is further configured to transmit the NAck frame to one of an Access Point (AP) that originated the frame, a peer STA that originated the frame.

19. A sniffer for communicating over a wireless network, the sniffer comprising:
at least one processor configured to detect a Negative Acknowledgement (NAck) frame, which was transmitted from a Station (STA) in response to the STA receiving a frame over a wireless network, and to determine if the received frame required acknowledgment.

20. A non-transitory computer-readable medium having stored thereon a plurality of executable instructions, the plurality of instructions comprising instructions to:
transmit/receive, at a Station (STA), a frame over a wireless network;
if the frame is corrupted, determine if the frame requires acknowledgement; and
if the frame requires acknowledgement, transmit a Negative Ack (NAck) frame.
